(19) United States
(12) Patent Application Publication
(10) Pub. No.: US 2002/0035568 A1
(43) Pub. Date: Mar. 21, 2002

(54) Method and apparatus supporting dynamically adaptive user interactions in a multimodal communication system

(76) Inventors: Mark Louis Benthin, Montreal (CA); Hung Nguyen, Montreal (CA); Pardo Mustillo, Montreal West (CA); Henry Chi Leung Tam, Brossard (CA); Shan Cai, Lasalle (CA); Yajaira Contreras, Montreal (CA); Denis Martineau, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 09/742,291

(22) Filed: Dec. 22, 2000

Related U.S. Application Data
(60) Provisional application No. 60/200,338, filed on Apr. 28, 2000.

(51) Int. Cl. G06F 17/30; G06F 17/60

(52) U.S. Cl. 707/102; 707/104.1; 705/26; 707/10; 345/745; 345/744; 705/14

(57) ABSTRACT

For electronic marketing to be successful, there is a need to personalize and target product or service information as much as possible to the evolving needs of customers. There is also the need to make adapting and targeting of the information controllable by product managers and marketing people, rather than by Web server programmers. The present invention relates to a method and apparatus for controlling an automatic, electronic presentation to a customer. The invention relates further to a marketing campaign manager for business and consumer electronic commerce marketing involving automatic presentations to customers.

The present application claims priority of U.S. Provisional Patent Application No. 60/200,338 filed Apr. 28, 2000.

### FIELD OF THE INVENTION

The present invention relates to a method and apparatus for controlling an automatic, electronic presentation to a customer. The invention relates further to a marketing campaign manager for business and consumer electronic commerce marketing involving automatic presentations to customers.

### BACKGROUND OF THE INVENTION

The Internet allows marketing information to reach customers in an efficient manner, previously unknown. The art and science of marketing requires the ability to customize products and services as well as information concerning those products and services to meet the needs of customers. There are two basic currently implemented mechanisms to identify customers when accessing information from HTML servers using Internet HTML browsers. Either the customer enters information allowing the HTML server to identify the customer and store customer profile data, or the server uses what is known as “cookie” data, which are passively collected from previous browsing. It is known with Internet HTML browsers to store locally on the browser computer data files called “cookies” which contain information stored by HTML pages retrieved during past browsing. Such cookies can be used to pass information concerning a customer to an HTML server.

In both cases of customer profiling, such servers can adapt the information provided to customers as a function of customer profile data. For example, the first page of a Web site retrieved in response to requesting the home page of the Web site can be adapted according to the customer profile data. Such adapting is based on rules established in the programming of the Web server pages, and does not involve any significant change in content and structure of the Web site. The state of the art is thus only partially effective in giving customers the information they want or need.

For electronic marketing to be successful, there is a need to dynamically adapt information, as well as products or services as much as possible to the evolving needs of customers. There is also the need to make adapting of the information controllable by product managers and marketing people, rather than Web server programmers. This is important because members of a customer segment may change over time based on dynamic changes in their individual, extensible profiles.

Forrester Research, in its 1999 report, found that Web sites ignore some important business fundamentals. Forrester found that business-to-business Web sites, for example, did not take into consideration customer goals and failed to provide the user with “a positive experience.” More importantly, Forrester Research found that none of the business-to-business sites it researched provided even minimal personalized content. What is missing is an effective, dynamic, adaptive dialog with customers based on dynamic, extensible customer profile data and customer segmentation based on evolving profiles. The dialog also needs to interact with customers regardless of media or technology, extending both the interaction and the customer knowledge database to further contribute to dialogs with customers, all fully controllable by marketers.

### SUMMARY OF THE INVENTION

It is one object of the present invention to provide an interface for marketing people to program marketing campaigns within the context of electronic customer information server systems serving a group of customers.

It is another object of the invention to provide a customer information or business and consumer e-commerce server that is able to be dynamically adapted in accordance with parameters defined by marketing managers.

It is a further object of the invention to provide a customer dialog processor able to determine from electronic, current and past dialog, and other data including existing legacy systems, customer service and support agents, point of sales data, wireless, electronic device interaction, and other entities identifying a profile of a customer which one of a number of campaigns should be used, and then to automatically generate information presentation or business and consumer e-commerce interaction behavior parameters.

It is yet another object of the present invention to provide a marketing campaign monitoring station able to collect, analyze, and display information concerning customer responses to dialog interactions associated with customer groups and with a marketing campaign.

The invention also provides a method of marketing products and/or services by providing adaptable electronically controlled dissemination of related information or business and consumer e-commerce interactivity, and then by controlling such interactivity according to electronic marketing campaigns defined by marketing people.

According to one aspect of the invention, there is provided an apparatus for controlling an automatic presentation of information to a customer. This apparatus comprises a customer profile database containing profile information about customers, a customer profile manager providing current customer data concerning a customer receiving the automatic presentation, a customer segmentation manager allowing customer profiles to be segmented based on campaigns, user actions, or both, a) a campaign editor accepting user input to define campaign definition data sets containing parameters for selecting customers according to the profile information about customers stored in the customer profile database and for defining associated product or service information, a customer dialog processor receiving a plurality of said campaign definition data sets and the current customer data, and outputting recommended presentation parameters defining a presentation in accordance with a campaign associated with the plurality of campaign definition data sets, and a customer information server connected to a data store of automatic presentation information including said product or service information and to a customer presentation interface device associated with the current customer, the customer information server receiving the presentation parameters and providing the presentation by selecting information from the data store of automatic presentation information in accordance with said campaign.

According to another approach of this invention, customer profiles are created representing individuals' roles in the business, the companies being represented, and the relationship to other individuals, their roles, as well as products, contracts, etc., and provide the functionality to manage highly extensible profiles facilitating online, real-time additions to the customer knowledge base that are the result of every targeted customer interaction and permitting the possibility of extending the profile, ready to be used immediately, producing customer profiles that are complex, rich in information, contextual, and business-focused.

Preferably, the customer profile manager is connected to the customer information server and receives login information from the current customer. This login information preferably allows the customer profile manager to retrieve any previously stored profile information about the current customer from the customer profile database. The customer profile manager may also preferably output data concerning the current customer in the customer profile database with a view to build up this database. The customer information server, in one preferred embodiment, is an HTML or Web server, and the customer profile manager detects browser input from the current customer and includes information extracted from the browser input in the customer profile database. Such browser input may include which pages are requested from the browser and the timing of such requests.

Preferably, the customer profile database contains data on customer response, and the campaign editor comprises a customer behavior analysis module connected to the customer profile database and outputting data indicative of customer response to at least one of the plurality of campaigns. Preferably, the system further comprises a customer segmentation manager allowing customer profiles to be segmented based on campaigns, user actions, or both. Membership in a particular customer segment may be fixed (explicit) or dynamic (evolving).

### BRIEF DESCRIPTION OF THE DRAWINGS

These and other objects of the present invention will be better understood by way of the following detailed description of a preferred embodiment, which is given as a non-limiting explicit example, with reference to the appended drawings in which:

FIG. 1 is a schematic block diagram of the preferred embodiment in which a number of customers having HTML browsers are connected to an information server whose content is adapted in accordance with each customers profile data and a plurality of marketing campaigns;

FIGS. 2A and 2B are a flow charts of the main steps in using the system according to preferred embodiments of the present invention;

FIG. 3 is a flow chart of the steps carried out to publish content of a dialog to the customer; and

FIG. 4 is an example of an organizational chart of the dialog tree pages in which the paths that can be followed by a user are identified.

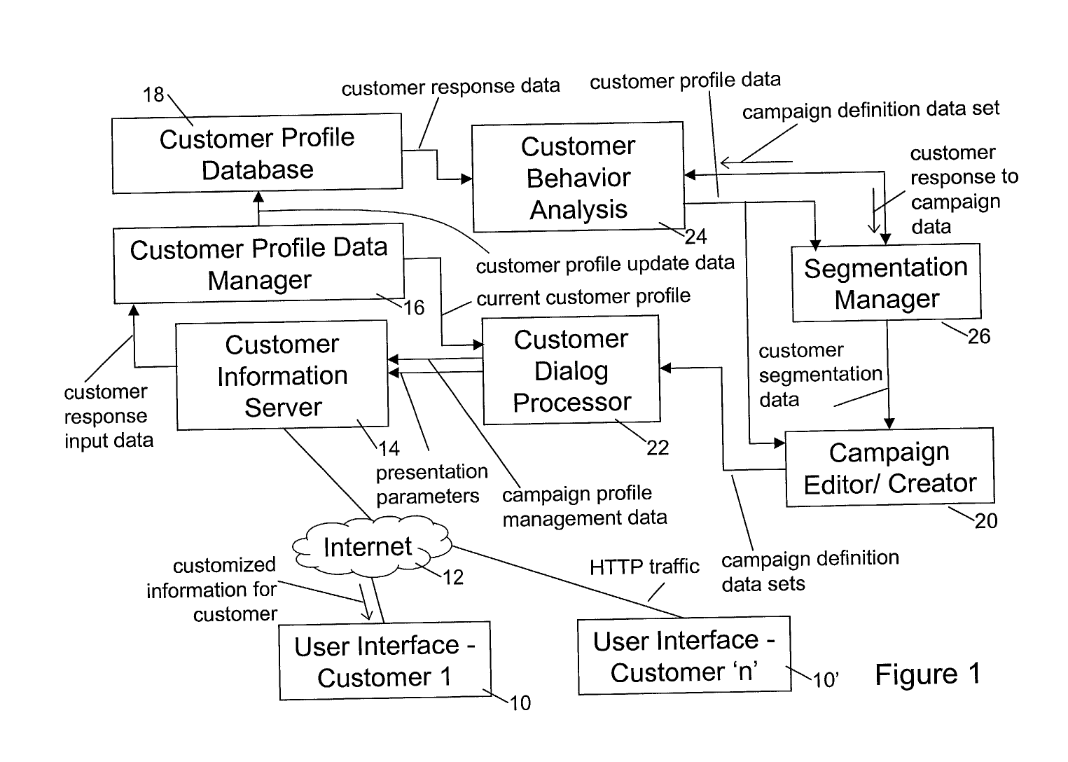

### DETAILED DESCRIPTION OF THE PREFERRED EMBODIMENT

In the preferred embodiment, the information being automatically presented to customers is HTML-based information sent via the Internet. Each customer uses a browser 10 or any other related electronic interaction input device existing now or in the future (e.g., phone, wireless, point-of-sale device, etc.) to communicate via the network 12 with an HTML information server 14. The server 14 in the preferred embodiment is an HTML server, which that is adapted to serve different information to different customers in accordance with presentation parameters. The customer Information Server also receives campaign profile management data used to manage which campaign profiles are presented to the customer.

The server 14 is also adapted to acquire customer profile input data, which are transmitted to a customer profile data manager 16. The customer profile input data may be login data identifying the specific customer, or they may be data identifying the customer browser 10 or 10′ from a previous session by way of cookie data. The customer profile input data may also comprise customer browsing response information that the server 14 detects and outputs during a browsing session to the customer profile data manager 16. The customer profile data manager 16 provides customer profile update data to the customer profile database 18. As can be appreciated, a customer profile may include information such as demographic information, purchasing habits including purchasing history, navigation habits and history, as well as specific answers to online survey questions, or offline user activities. A profile is extensible to individual users, their group, and other entity associations.

Customer profile data are collected from many different sources into the central customer profile database 18. These sources of data can be any interaction input device existing now or in the future (e.g., phone, wireless, point-of-sale device, etc.). The customer profile data are parsed through a conversion interface, which converts the data to a data interchange standard format. This data interchange standard format is the same regardless of the source of the data, and can be any existing or future standard, such as HTML, XML, SOAP, etc. The data are then imported into the customer profile database, which is also compliant with the data interchange standard.

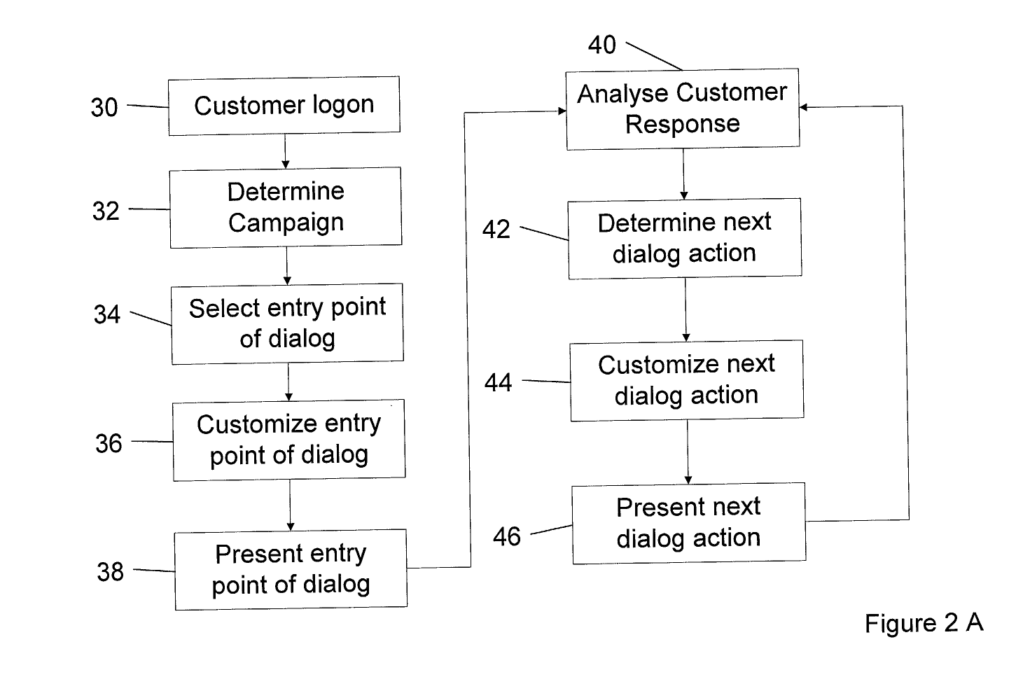

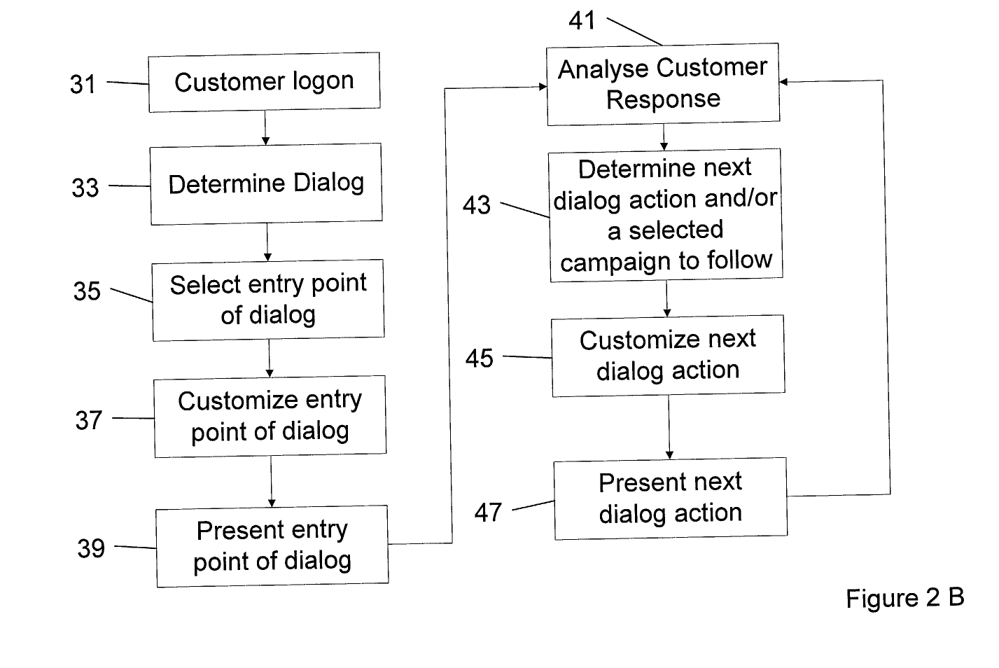

FIG. 2A is a flow chart of the steps carried out by the customer when using the system of the present invention. The customer first logs in 30 the system. A campaign is then determined 32 to be presented to the customer. A first segment of a dialog is selected 34 according to the campaign chosen. The segment is customized using the customer's preferences 36 to be presented on the customer's interface. The segment is then presented 38. If the prompt contained in the segment is attractive, the customer will probably perform an action such as clicking on a link. This action will be recorded and analyzed 40. The user's action generates a system event, which may cause further system responses This will determine the next segment of the dialog to present 42. Again, the segment will first be customized 44 and then presented 46. This process will continue until the dialog is over.

Dialogs are dynamically generated based on user profiles, actions, and system events. They often do not consist of fixed pages in a straight decision tree. User actions create system events, which may cause further system responses (e.g., delayed email to a customer based on a scheduled system response).

FIG. 2B is another flow chart of the steps carried out by the customer when using an alternative embodiment of the present invention. There are two modes of navigation: campaign based, as described in FIG. 2A, as well as dialog-based, as shown in FIG. 2B. The system can use either of these two methods. For example, the marketer may select a campaign to run, and the system will select the most appropriate dialogs as described above. Alternately, the marketer may decide to use a dialog to interact with a customer, which may or may nor be tied directly to a campaign. In either case, however, the marketer can control and change the type of experience that the customer will receive.

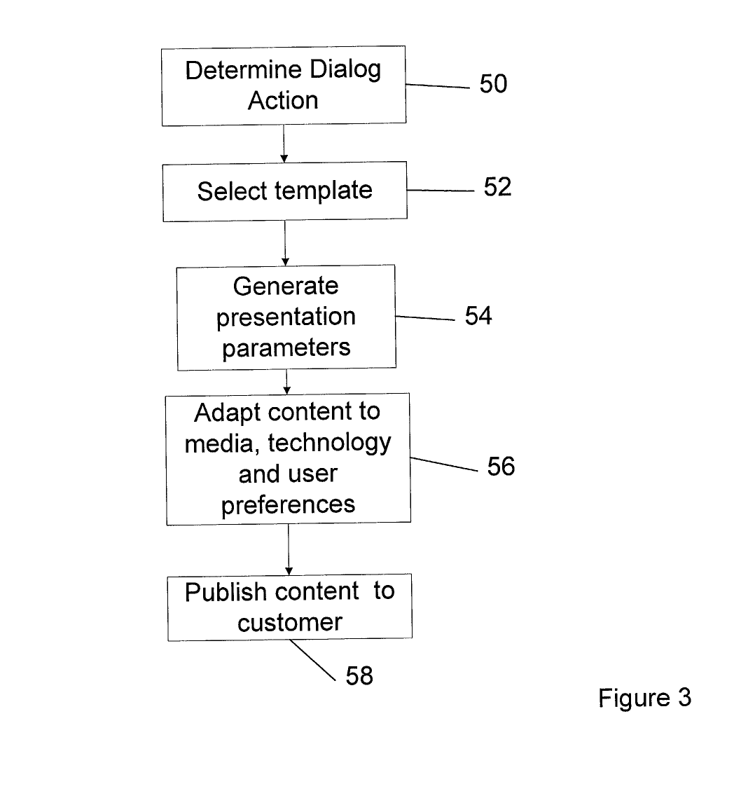

Referring now to FIG. 3, the customization of the dialog segments will now be detailed. The Dialog action is first determined 50. The template for the presentation is selected 52. The presentation parameters are generated for the template 54, and the content is adapted to the media and technology (i.e., template is rendered in the appropriate presentation format) used by the customer to access the system, and his or her preferences that are stored in his or her profile 56. Then, the content is published to the customer 58.

In accordance with an embodiment of the present invention, there is provided a Customer Segmentation Manager 26 which uses the customer response to campaign data and the customer profile data to output customer segmentation data for the Campaign Editor/Creator 20.

In accordance with the present invention, a campaign editor and creator 20 allows a person in marketing to create and monitor the progress of a marketing campaign. The campaign editor/creator 20 allows the marketing user to create a new campaign using a user interface. In the preferred embodiment, the following steps are involved in defining a new campaign.

The first step is simply to provide a name for the campaign. The second step is to select the product or products or service or services to be involved in the campaign. The user is able to select information, including products and/or services according to different categories. The next step is to select customer profiles. The campaign editor 20 receives a full specification of the customer profile data set. This allows customer groups to be targeted. In the preferred embodiment, the step of selecting customer profiles also includes the use of customer action filters, which allows more sophisticated logic and arithmetic to be involved in deciding customer profiles that are to be selected. For example, a filter would be: customers who are medical doctors in private practice who have current drug prescription habits, and who have expressed interest in a specific type of information about a new drug. Customer groups may be created at this point or at another time by following these sub-steps: naming the customer group and creating constraints. Membership in customer groups may change over time based on the evolution of user profiles and a customer may belong to more than one customer group.

The next step involved in defining a campaign in the campaign editor/creator 20 is to specify what HTML content is to be provided to the customer (known as dialog). A campaign may also include within its definition that it is to be activated when a customer selects a predetermined page within an HTML site. The campaign editor may be used to specify the content to be automatically presented to a customer by specifying a particular template for an HTML page presentation. Such templates may be predefined using a separate dialog or template definition module. Dialogs may be created at this point or at another time by following these sub-steps: naming the dialog, selecting customer groups, choosing dialog templates, and specifying the rules for adding content to the dialog page.

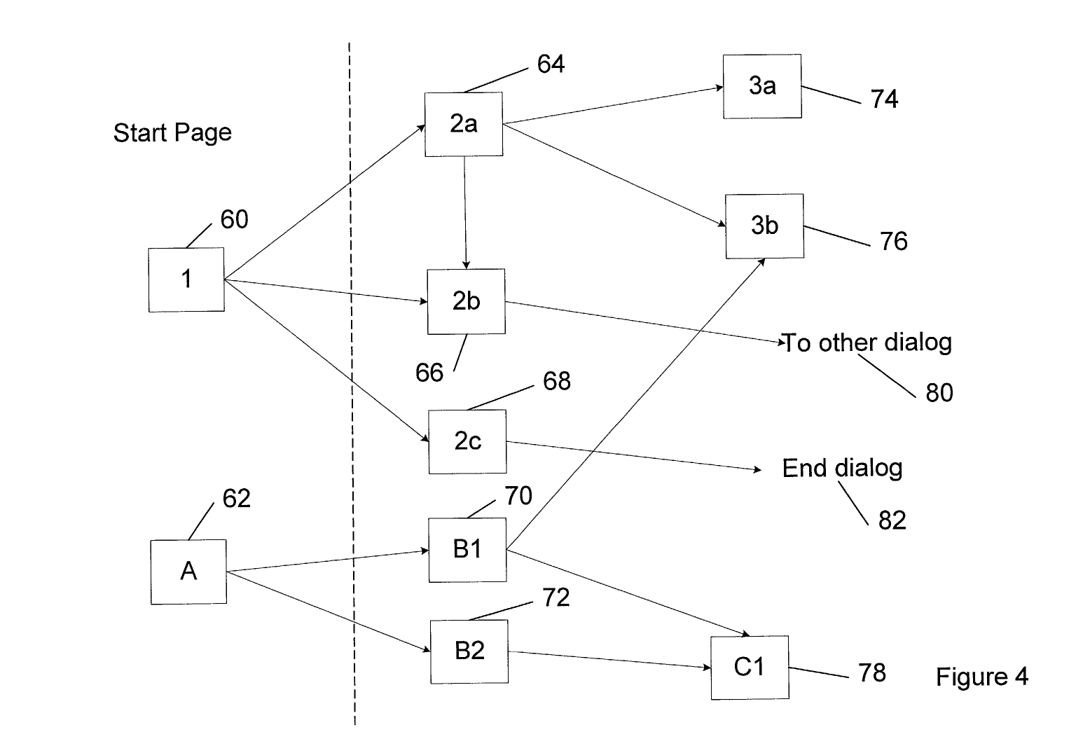

In the case of campaign navigation, the dialog tree consists of a custom decision tree specific to the selected campaign. The customer navigates this dialog tree based on his or her decisions at each step of the dialog. Thus, in FIG. 4, the customer's decisions can influence which step of the following steps he or she will be presented with. For example, if a customer is first presented with start page 1 (60), he or she can then be presented with segments 2a (64), 2b (66), or 2c (68), depending on the conditions formulated for each dialog and the customer's interaction with the system. As with campaign selection, any sort of decision rule can be established if two or more dialog steps are applicable (random selection, statistical weights, priorities, etc.).

In the case of a dialog navigation, the dialogs are dynamically generated based on individual profile history, which may also impact usage.

If no more dialog steps are applicable, then the dialog is considered over (82). Another way to exit the current dialog is when a specific dialog step refers to another dialog (80) or campaign, in which case the new dialog or campaign is initiated and the current dialog is terminated. However, a dialog is not necessarily terminated when a customer exits the system, as the dialog can be carried over many subsequent sessions. It is possible for segments of the dialog tree to refer to one another as is the case with segments 2a and 2b. It is also possible to be sent to a segment from a different dialog tree as is illustrated with the arrow between the segment B1 (70) and 3b (76).

The next step involved in defining a campaign in the campaign editor/creator 20 is to define what promotion or marketing activity is to be provided in response to identifying customers who match the campaign. The action may be simply to offer special advertising information, or to provide the customer with an offer to receive a product sample, or to provide the customer with an offer to receive a chance to win a product or service, or some other form of promotion.

The next step in defining the campaign is to identify scheduling for the campaign. The user needs to identify the frequency of occurrence (i.e., start date and time, end date and time, whether the campaign is offered at all times or only selected times, as well as on all days or only selected days) and the total number of times the campaign is shown. The user can be provided with a campaign summary view of each campaign programmed using the campaign editor 20. Such campaign summaries can be printed out for review.

The campaign profile management data are used to determine priorities for specific campaigns or dialogs. Among the applicable campaigns, a single campaign can be selected. This is done in a variety of ways, depending on the administrator's needs: a campaign can be selected randomly among applicable campaigns; various campaigns can be given a different statistical weight; campaigns can be given priorities, such that a given campaign will always be presented regardless of other available campaigns; or any other method of selection can be used. Preferably, only one campaign is selected for presentation.

Alternatively, a single dialog can be selected. This is done in a variety of ways, depending on the administrator's needs: a dialog can be selected randomly among applicable dialogs; various dialogs can be given a different statistical weight; dialogs can be given priorities, such that a given dialog will always be presented regardless of other available dialogs; or any other method of selection can be used. Preferably, only one dialog is selected for presentation.

The result of using the campaign editor is the creation of a campaign definition data set. The information server 14 in conjunction with the customer profile data manager 16, the campaign profile management data and the customer dialog processor 22 determines for each identified customer accessing the server 14 what arrangement of HTML content is to be automatically served to each particular customer according to the campaign definition data sets. The customer dialog processor 22 reads the current customer profile and the campaign definition data sets to determine which one or which ones of the campaign definition data sets apply to a particular customer. Customer profile data can also be obtained from a plurality of sources such as existing legacy databases, customer service/support logs, wireless devices customer information data, point-of-sales data, other enterprises, etc.

Campaign definition data sets may be given a particular ranking or priority. It is also possible within the present invention to provide a mechanism for automatically presenting to customers, in a sequential order, all information according to campaigns which apply to a customer according to the customer profile. When two or more campaigns apply to a customer, it may also be possible to randomly assign a presentation defined by a particular campaign to any particular customer in order that campaigns are distributed according to distribution rules among customers. The customer dialog processor 22 determines what presentation should be automatically presented to a customer and outputs presentation parameters to the customer information server 14 in order that the appropriate HTML segments may be combined or compiled in order to provide the appropriate presentation information to the particular customer.

According to the invention, there is also provided a customer behavior analysis module 24 which reviews the customer response data from the customer profile database 18 and matches the same with the campaign definition data sets in order to provide a statistical report on customer response to each campaign. The campaign editor 20 can display such statistics for viewing and/or printing by the user. It will be appreciated that the user is able to detect trends as well as simple success and failure of a campaign in order to provide an opportunity to optimize a campaign, cancel a campaign or continue with a campaign.

In short, the preferred embodiment of the present invention uses content delivery and user profiling methods based on content and presentation rules known as campaigns and dialogs. A campaign is a set of content and presentation rules used to target a promotion to a specified user group, following a specific schedule. Dialogs are content sequencing rules. They represent a decision tree, which the customer then navigates depending on his or her choices, and on their profiles.

For example, a typical campaign could specify the promotion of medical equipment to lab technicians in the first two weeks of the month. A typical dialog would include the sequence of pages the customer will receive as he or she navigates through the campaign. It will be appreciated that in the case of a customer utilizing a voice browser to navigate through the system, the “pages” in the dialog tree correspond to presentation segments which would be audible as opposed to visual/audible with a Web browser.

The delivery of a campaign to customers is initiated once the customer is matched to an existing customer profile by the system. This is done through a variety of means: by using browser cookies stored on the user's system, by manual login of the customer, or by any other means, present or future, of positive identification of a customer by the system. In the event that no profile in the profile database matches the current user, a new one is created before the dialog delivery process is initiated.

The appropriate campaign for the specified user is then selected. The selected dialog is presented to the customer. If the customer is initiating a campaign, a default dialog is presented to the user. At the outcome of this step, the customer has received content tailored to his or her interface.

Once the customer has performed an action recorded by the system (clicking on an item, turning off the device, exiting the system, giving a vocal command, etc.), this action is analyzed. First, it is converted into manageable data by the appropriate parsing device. Then, this data are compared with the system's existing profile attributes to determine if this new data warrants a modification to the existing profile. If this is the case, then the profile is updated according to the specified rule.

Based on the updated customer profile, and on the current stage of the dialog, the next dialog step to be presented to the customer is determined. The dialog delivery process is over if the current profile and dialog step do not satisfy any subsequent dialog step conditions, or if the customer has terminated the session. Otherwise, the new dialog is selected and the process is repeated.

Based on the selection rules of all campaigns, the campaigns applicable to the current customer at the present time are selected. Naturally, if the campaign to display is already specified, the campaign is simply retrieved and not determined.

To every dialog step corresponds a presentation template. This template is not specific to the presentation device, and can consist only of content and presentation restrictions.

Based on the restrictions of the template, the presentation parameters are collected. If an external content and presentation manager exists, then the input from this manager is computed. The purpose of this step is to take the general restrictions of the template selected above, and transform them into specific content and presentation instructions that are not yet device-specific. One example of such a document is an XML file, but can consist of any type of data interchange format.

Then, the presentation and content parameters are tailored to the customer's device. This is done, for instance, by applying an XSL translation filter to the XML data, but can consist of any form of device-specific translation made on generic presentation and content parameters.

The final content is published to the customer. For example, if the customer is using a traditional Web browser, then the final HTML file is sent to the customer's device.

Here is an example of the evolution of a user's profile throughout a visit to a Website featuring campaign and dialog delivery.

Note that the technological and strategic choices made herewith are examples of preferred embodiments and not restrictions on the invention. Thus, for instance, when the example states that the customer is using a Web browser on a PC, this is an example of a device that could be used to access the system. The method of access of the user could well have been a wireless device, or any other present or future device of accessing Web content.

Likewise, the method of profiling the user, and the choice of profiling data, does not represent a restriction on the invention, but rather a deliberate choice for the sake of illustrating the invention in a specific example.

In the context of this example, the following elements are known and set:

The campaign and dialog delivery invention is integrated into an entertainment Website;

The Website can be accessed either through a traditional Web browser such as Netscape or Internet Explorer, or through a wireless device, for instance, through an AvantGo channel on a Palm Pilot;

In this case, the customer has both of these devices;

The customer is recognized through cookies stored on his machine, and does not need to log on manually;

The customer has already created a profile.

The customer's profile contains the following information, entered manually by the customer and captured from observing his or her actions:

Nickname: John242

Name: Doe

Surname: John

City: New York City

State: New York

Email: john.doe@bigcie.com

Occupation: Physician

Place of Work: Hospital

No. of Beds: More than 500

Field: Cardiology

Main Interest: Cardiovascular surgery

Other Interest: Nuclear cardiology

Salary Range: 125,000-200,000

Attended The American Heart Association Meeting in Florida

Purchased 5 medical books during the past month

During customer logon, the customer is recognized by the system through the use of a cookie stored on the system.

To select applicable campaigns, the system determines that there are two campaigns that apply to John242:

CARDIO_CONF2: Main interest: Cardiovascular Surgery; State: New York

NUCCARDIO_BOOK: Main or Other interest: Nuclear cardiology; Place of work: Hospital; Presented CARDIO_CONF2: No entry

To determine which campaign to use, the administrator has determined that the NUCCARDIO_BOOK offer has a higher priority than the CARDIO_CONF2 campaign. Thus, the NUCCARDIO_BOOK campaign is selected. The customers profile is updated with the following information: Presented NUCCARDIO_BOOK? Yes. This way, the customer will not be presented with this ad (campaign) more than once, because once it has been received once, the value stored in the profile makes it impossible to satisfy the conditions as specified in the previous step.

The first dialog step of the NUCCARDIO_BOOK corresponds to a template. This is the template that is selected. The template is a Web page that will present a book series on nuclear cardiology for hospital employees in a corner of the page, while showing the default welcome screen for the rest.

In order to generate presentation parameters, the system determines that John242 likes the screen background in dark blue, and the letters in white, by interfacing with the presentation manager software. The resulting information is gathered in an XML file.

Using an XSL translation file, the XML file is converted into HTML, so it can be delivered to the customer's PC-based browser.

To publish the content to the customer, the HTML file is sent to the customer over the Internet, and appears as a Web page in the customer's browser.

The customer, intrigued by the offer, clicks on the ad for the book series on nuclear cardiology. This is noted by the system as a customer response to the campaign.

To determine the next dialog step, the dialog sequence takes into account two possible choices: either the customer clicks on the ad, in which case the dialog sequence B will be shown, or he doesn't, in which case the dialog will be terminated. In this case, the data collected by the system indicates that dialog B must be shown. The profile is updated with the following information: Interested in book ads: A little.

Then, the process starts over. Dialog B will be presented to the customer, with the choice of buying or not the proposed product. Throughout this process, the customer was presented with an ad that was specific to his needs, and the system has learned more about John242: namely, that the customer is interested in book offers online.

Eventually, the customer will turn off his browser, reject selections, or access the Website with his wireless device. If the customer refuses to click on cardiovascular surgery ad campaigns in the future, then his preferences will reflect that change of heart, even though the initial profile implied the opposite.

Dialog steps can be combined together to present content triggered by different characteristics of the customer.

Table 1 shows an example template. A template is a simple XML file preferably containing three sections:

Headers to identify the template;

Building blocks, which are API libraries to access the back-end functions;

HTML presentation files, which represent the actual presentation data.

TABLE 1
Example template:

#param template_name=“welcome”
#param template_category=“xray”
#param sa_questions_type=“Question”
#parse “/blocks/sa_object.block”
#parse “/blocks/sa_user.block”
#parse “/blocks/sa_sendinfo.block”
#parse “/blocks/sa_question.block”
#include “/html/head.htm”
#include “/html/contain.htm”

It will be understood that numerous modifications thereto will appear to those skilled in the art. Accordingly, the above description and accompanying drawings should be taken as illustrative of the invention and not in a limiting sense.

It will further be understood that it is intended to cover any variations, uses, or adaptations of the invention following, in general, the principles of the invention and including such departures form the present disclosure as come within known or customary practice within the art to which the invention pertains and as may be applied to the essential features hereinbefore set forth, and as follows in the scope of the appended claims.

What is claimed is:

1. An apparatus for controlling an automatic presentation of information to a customer comprising:
a customer profile database containing profile information about customers;
a customer profile manager providing current customer data concerning a customer receiving the automatic presentation;
a campaign editor accepting user input to define campaign definition data sets containing parameters for selecting customers according to the profile information about customers stored in the customer profile database and for defining associated product or service information;
a customer dialog processor receiving a plurality of said campaign definition data sets and the current customer data from the media of contact, and outputting presentation parameters defining a presentation in accordance with a campaign associated with the plurality of campaign definition data sets; and
a customer information server connected to a data store of automatic presentation information including said product or service information and to a customer presentation interface device associated with the current customer, the customer information server receiving the presentation parameters and providing the presentation by selecting information from the data store of automatic presentation information in accordance with said campaign.

2. The apparatus as claimed in claim 1, wherein the customer profile manager is connected to said customer information server and receives login information from the current customer.

3. The apparatus as claimed in claim 2, wherein the customer profile manager outputs data concerning the current customer in the customer profile database.

4. The apparatus as claimed in claim 3, wherein the customer information server is a Web server, and the customer profile manager detects browser input from the current customer and includes information extracted from the browser input in the customer profile database.

5. The apparatus as claimed in claim 1, wherein the customer profile database contains data on customer response, and the campaign editor comprises a customer behavior analysis module connected to the customer profile database and outputting data indicative of customer response to at least one of the plurality of campaigns.

6. The apparatus as claimed in claim 1, further comprising:
a dynamic dialog generator that interacts with other system elements to provide personalized customer dialog and is dynamically and immediately extensible by data imported from various media.

7. The apparatus as claimed in claim 1, further comprising:
a customer segmentation manager that uses campaign definition data sets as well as current customer data to create customer segmentation.

8. A method for controlling an automatic presentation of information to a customer comprising:
providing current customer data concerning a customer receiving the automatic presentation;
accepting user input in response to said automatic presentation;
defining campaign definition data sets containing parameters for selecting customers according to the profile information about customers stored in the customer profile database and for defining associated product or service information;
receiving a plurality of said campaign definition data sets and the current customer data from the media of contact,
outputting presentation parameters defining a presentation in accordance with a campaign associated with the plurality of campaign definition data sets; and
receiving the presentation parameters and providing the presentation by selecting information from the data store of automatic presentation information in accordance with said campaign.

9. The method as claimed in claim 8, wherein login information from the current customer is received prior providing current customer data concerning a customer receiving the automatic presentation.

10. The method as claimed in claim 9, further comprising a step of outputting data concerning the current customer in a customer profile database.

11. The method as claimed in claim 8, wherein the customer profile contains data on customer response, and the method further comprises outputting data indicative of customer response to at least one of the plurality of campaigns.
